(19) United States
(12) Patent Application Publication
(10) Pub. No.: US 2011/0308538 A1
(43) Pub. Date: Dec. 22, 2011

(54) EDIBLE PIPE AND METHOD THEREFOR

(76) Inventors: Quinten Jarvis, Goodyear, AZ (US); Tim Rael, Litchfield Park, AZ (US)

(21) Appl. No.: 12/819,114

(22) Filed: Jun. 18, 2010

(51) Int. Cl. A24F 5/00; A23P 1/08; A23P 1/10; A21D 13/00

(52) U.S. Cl. 131/226; 426/307; 426/391; 426/549

(57) ABSTRACT

An edible pipe includes a bowl, a stem, and a mouthpiece manufactured by a process that includes forming a patty having an approximately rectangular shape. The process includes cooking the patty, and rolling the cooked patty into a cylindrical shape by inserting the cooked patty into a rolling device having a cylindrical wall with a closed end. The cylindrical wall defines an interior volume of the rolling device and includes an opening along a length of the cylindrical wall for receiving the cooked patty. The rolling device includes a shaft mounted to the closed end. The shaft runs through the interior volume of the rolling device. Rolling the cooked patty includes winding the cooked patty around the shaft of the rolling device, and removing the rolled cooked patty from the rolling device. The process includes forming a bend in the rolled cooked patty to form the edible pipe.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The present invention relates generally to pipes and, more particularly, to an edible pipe and a system and method for manufacturing the edible pipe.

Man has been using tobacco for millennia. Although tobacco can be consumed in many different forms such as chew, snuff, and dipping tobacco, smoking is by far the most popular method of consuming tobacco.

To be smoked, leaves from a tobacco plant are first collected and dried or cured. While curing, chemical reactions in the tobacco leaf cause oxidation and degradation of various chemicals in the leaf, as well as the formation of sugars from starches in the leaf—all modifying the final flavor of the smoked tobacco product. Tobacco can be cured in many ways, including air curing, fire curing, flue curing, and sun curing. After drying and curing, the leaves are cut into small strips, sometimes referred to as shredding, and packaged for an end consumer.

When used in cigarettes or cigars, the shredded tobacco product is collected and tightly rolled within an outer layer of inflammable material—usually paper for cigarettes and a sheet of dried tobacco for cigars. To use the cigarette or cigar, the user ignites one end of the cigarette or cigar while inhaling from the other end causing an inhalation of smoke generated by the burned tobacco product. In some cases, in addition to tobacco, additives may be combined into the cigarette or cigar to modify a flavor of the tobacco.

Tobacco may also be smoked using a smoking pipe. Pipes allow a user to smoke shredded tobacco similar to that rolled within cigarettes and cigars. To facilitate smoking, however, the tobacco may be substantially moister and more coarsely cut than the tobacco found in cigarettes and cigars. These characteristics of smoking pipe tobacco assist the movement of air through the pipe and keep the tobacco burning for an optimal period of time. As above, the tobacco may include additives to change a flavor of the tobacco. Furthermore, blends of different tobacco leaves may be combined to control the ultimate flavor and experience when the tobacco is smoked.

Pipes usually include a bowl into which the tobacco may be packed and burned. The bowl is connected to a stem, which is ultimately connected to a mouthpiece. To smoke tobacco using the pipe, a user first packs tobacco into the pipe's bowl. Generally, this is done with the user conveying tobacco into the bowl of the pipe by hand. The user adds a bit of tobacco at a time, and, after each addition, compresses the tobacco into the bowl manually. The degree to which the tobacco is packed into the bowl affects the density of the tobacco within the bowl and, consequently, the ease with which the user can draw air through the packed tobacco as the tobacco burns. The more densely the tobacco is packed, the more difficult it is to pull air through the tobacco, and the longer the tobacco burns. Conversely, it is easier to pull air through lightly-packed tobacco, but lightly-packed tobacco burns more quickly.

After packing the bowl with tobacco, the user ignites the packed tobacco. As the tobacco burns it generates smoke. The user then sucks on the mouthpiece of the pipe causing the smoke to pass from the bowl, through the stem, and through the mouthpiece into the user's mouth. The tobacco smoke can then be tasted and, eventually, released by the user.

Today, pipes take numerous forms. Some pipes allow for repeated use. The construction materials for repeated-use pipes can include wood, clay, various minerals, metals, glass, plastics, ceramics, and other materials that allow for the repeated burning of tobacco and use of the pipe. Sometimes, in the case of reusable pipes, the different components of the pipe including the bowl, stem and mouthpiece are each separable from one another, allowing a user to clean the pipe's different components for future uses.

Alternatively, pipes can be constructed from perishable materials. For example, sometimes fruits or vegetables are modified and used as smoking pipes. In that case, the user removes a portion of the fruit or vegetable to act as the bowl of the pipe. A channel or stem is then cored into the fruit or vegetable and connected to the bowl. The bowl is then packed with tobacco and ignited, and the user draws smoke from the bowl, through the stem into the user's mouth.

Although edible pipes manufactured in this manner are popular and fun to use, the fruit or vegetables tend to go bad quickly and their flavor can also modify the flavor of the tobacco.

### BRIEF SUMMARY OF THE INVENTION

In one embodiment, the present invention is an edible pipe including a bowl, a stem, and a mouthpiece manufactured by a process. The process includes forming a patty having an approximately rectangular shape. The patty includes fortune cookie batter. The process includes cooking the patty, and rolling the cooked patty into a cylindrical shape. Rolling the cooked patty includes inserting the cooked patty into a rolling device. The rolling device includes a cylindrical wall having a closed end. The cylindrical wall defines an interior volume of the rolling device and includes an opening along a length of the cylindrical wall for receiving the cooked patty. The rolling device includes a shaft mounted to the closed end. The shaft runs through the interior volume of the rolling device. Rolling the cooked patty includes winding the cooked patty around the shaft of the rolling device, and removing the rolled cooked patty from the rolling device. The process includes forming a bend in the rolled cooked patty to form the edible pipe.

In another embodiment, the present invention is a method of manufacturing an edible pipe having a mouthpiece, stem and bowl. The method comprises forming a patty having an approximately rectangular shape. The patty includes fortune cookie batter. The method includes cooking the patty, rolling the cooked patty into a cylindrical shape, and forming a bend in the rolled cooked patty to form the edible pipe.

In another embodiment, the present invention is a method for manufacturing an edible pipe having a mouthpiece, stem and bowl. The method includes forming a patty having an approximately rectangular shape. The patty includes fortune cookie batter. The method includes removing a portion of a first corner of the patty, cooking the patty, rolling the cooked patty into a cylindrical shape, and forming a bend in the rolled cooked patty to form the edible pipe. The method includes forming a moisture resistant coating over at least a portion of the mouthpiece of the edible pipe. The moisture resistant coating includes an edible wax material.

In another embodiment, the present invention is an edible pipe. The edible pipe includes a cooked batter composition. The cooked batter composition has a mouthpiece, a stem, and a bowl. The mouthpiece, stem and bowl are in fluid communication. A bend is formed in the cooked batter composition between the stem and the bowl. The cooked batter composition includes a moisture resistant coating formed over the mouthpiece.

### BRIEF DESCRIPTION OF THE SEVERAL VIEWS OF THE DRAWINGS

The invention will hereafter be described with reference to the accompanying drawings, wherein like reference numerals denote like elements, and:

FIGS. 1A-1F are illustrations of the present edible pipe showing a perspective view, a right side view, a left side view, a front view, a top view, and a rear view, respectively;

FIG. 2 is an illustration of a method for manufacturing the edible pipe shown in FIGS. 1A-1F;

FIG. 3 is an illustration of an example patty prior to formation of the edible pipe;

FIGS. 4A and 4B are illustrations of an exemplary rolling device to facilitate the rolling step illustrated in FIG. 2;

FIGS. 5A-5D illustrate a method for using the rolling device of FIGS. 4A and 4B to form a cylindrically-shaped cooked patty;

FIG. 6 is an illustration of an alternative rolling stick for rolling the cooked patty for formation into the pipe shape;

FIG. 7 is an illustrated of a cone-shaped bowl plug that may be inserted into the bowl portion of the edible pipe to form the shape of bowl;

FIGS. 8A and 8B are illustrations of an example griddle for use in an automated cookie fabrication machine for manufacturing the present edible pipe;

FIG. 9 is a side view of an example baking machine incorporating the griddle illustrated in FIGS. 8A and 8B for manufacturing the present edible pipe; and

FIG. 10 is a top view of an example baking machine incorporating the griddle illustrated in FIGS. 8A and 8B for manufacturing the present edible pipe.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

The various aspects of the disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

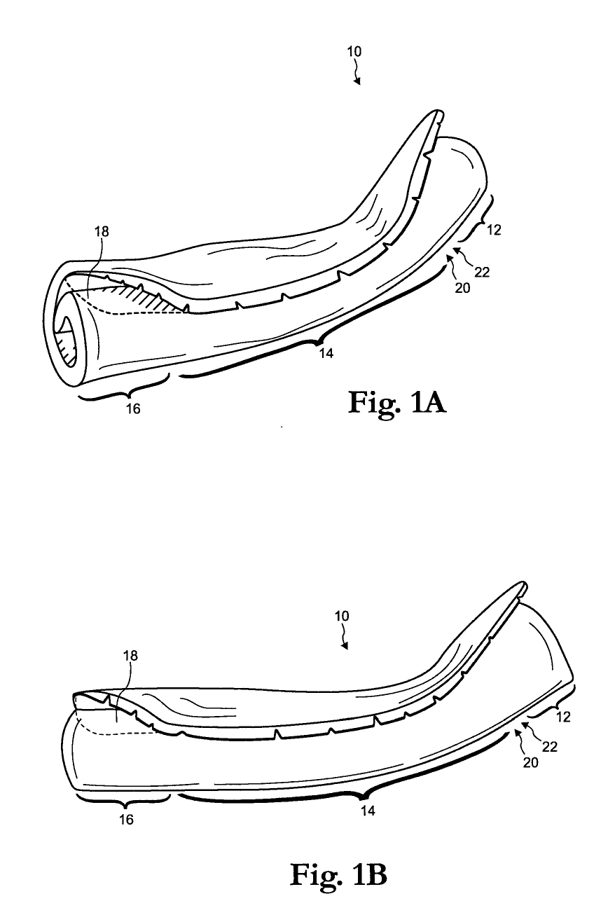

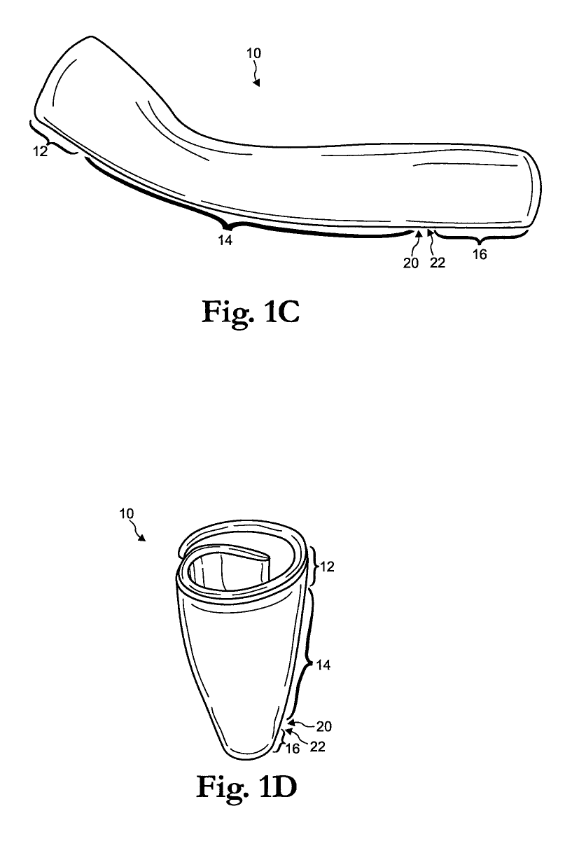

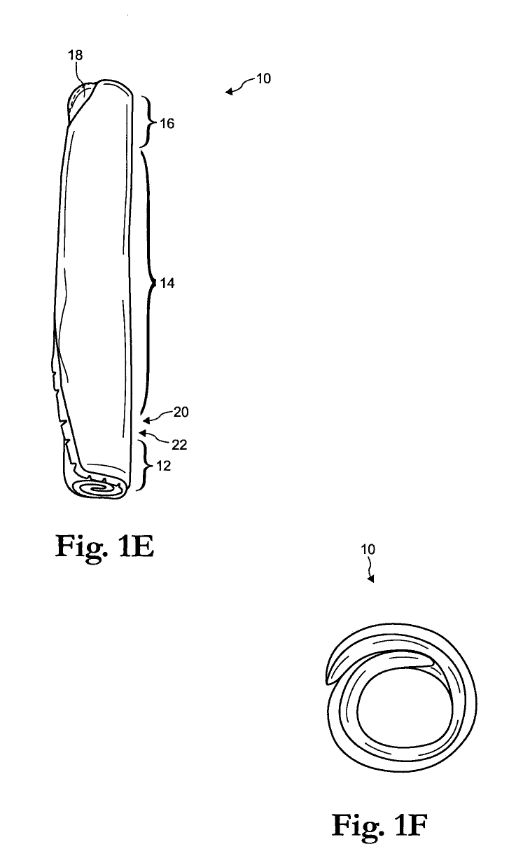

FIGS. 1A-1F are illustrations of edible pipe 10. FIG. 1A shows a perspective view of edible pipe 10. FIG. 1B shows a right side view of edible pipe 10. FIG. 1C shows a left side view of edible pipe 10. FIG. 1D shows a front view of edible pipe 10. FIG. 1E shows a top view of edible pipe 10. FIG. 1F shows a rear view of edible pipe 10.

Edible pipe 10 includes bowl 12 configured to receive tobacco. Bowl 12 is connected to stem 14 and stem 14 is connected to mouthpiece 16. Bend 20 is formed between stem 14 and bowl 12. Bend 20 may be formed at any appropriate angle that allows for use of pipe 10. As shown in FIGS. 1A-1F bowl shaft 22 may be formed between bowl 12 and stem 14 to extend bowl 12 away from bend 20.

Each of bowl 12, stem 14 and mouthpiece 16 are in fluid communication with one another. Accordingly, a user can draw air in through bowl 12, through stem 14 and, finally, through mouthpiece 16. This allows tobacco to be placed into bowl 12, packed, ignited, and smoked using pipe 10.

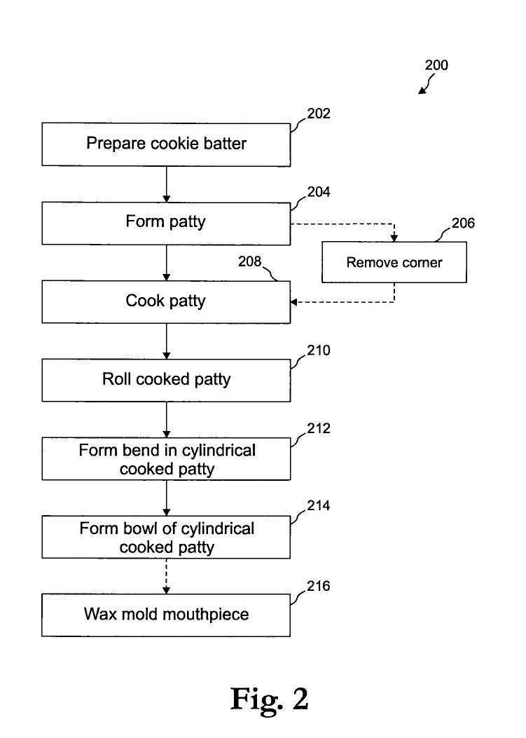

As shown in FIGS. 1A-1F, the various components of edible pipe 10 are each formed from a single continuous piece of material. In other implementations, however, the various components of pipe 10 (including bowl 12, stem 14, and mouthpiece 16) may each be formed separately and then joined together using adhesives such as sugar glue, or other edible mechanical connectors. Pipe 10 is fabricated from edible materials and may be manufactured, for example, according to the method illustrated in FIG. 2.

A moisture resistant coating may be formed over portions of mouthpiece 16 and, optionally, stem 14. The moisture resistant coating acts as a barrier to inhibit the transfer of moisture from the user's mouth to the material forming mouthpiece 16 while edible pipe 10 is used for smoking. The moisture resistant coating may include a wax material deposited over the mouthpiece using a conventional wax dip procedure, for example, and may include an edible material such as paraffin wax, but can include other moisture resistant, edible materials too.

In some cases, to form an additional protective layer over the surface of one or more of the components of pipe 10, a liquid sugar solution is sprayed or otherwise deposited over one or more of the components of edible pipe 10. The sugar solution, once dried, provides additional protection over a surface of pipe 10 further preventing the transmission of moisture into the material making up pipe 10.

In some implementations, mouthpiece 16 of edible pipe 10 is modified to facilitate use of pipe 10. As shown in FIGS. 1A-1F, a portion of mouthpiece 16 may be removed (the removed portion is shown in dashed lines and designated by element ‘18’) to enhance the seal between a user's mouth and mouthpiece 16. Removed portion 18 may be formed by removing a portion of (e.g., cutting a corner out of) the original patty used to fabricate pipe 10 prior to cooking (see step 206 of method 200 of FIG. 2). Alternatively, to modify mouthpiece 16, when the patty is first poured, a mold may be used for shaping the patty to have removed portion 18.

The modified mouthpiece 16 allows a user of pipe 10 to form an improved seal between the user's mouth and mouthpiece 16 of pipe 10 when smoking pipe 10. Without removed portion 18, as a user sucks on mouthpiece 16, air may be introduced between the layers of material comprising mouthpiece 16 from the side of mouthpiece 16 or stem 14. As a result, air would be drawn into the user's mouth that does not first pass through bowl 12. This would result in a frustrating user experience—the introduction of air around mouthpiece 16 would minimize the amount of air being drawn into pipe 10 through bowl 12 making it difficult to the use pipe 10 for smoking.

In the present implementation, pipe 10 is constructed using edible materials such as a fortune cookie material. The material is lightweight, but strong enough to maintain the shape of pipe 10, even during shipping, and to allow smoking of tobacco product within bowl 12. Although the material is porous and therefore may be receptive to moisture, as discussed above, a waterproof coating may be formed over mouthpiece 16 to protect mouthpiece 16 from moisture. Alternatively, other materials may be deposited or sprayed over pipe 10 to provide additional moisture protection. Also, because the material is porous, it is a poor conductor of a heat. As a result, even while smoking with pipe 10, bowl 12 of pipe 10 can be held by a user with minimal risk of burns.

Using the fortune cookie material, the pipe may be manufactured accordingly to the method illustrated in FIG. 2. In other implementations, however, the pipe may be manufactured using a pipe-shaped mold into which the cookie batter is poured and cooked. Alternatively, molds may be created for each of the components of the pipe. The molds can then be used to construct the individual components of the pipe which are then combined into the finished edible pipe product and fixed together using mechanical components or edible adhesive.

In one specific implementation of pipe 10, pipe 10 has the following dimensions: outer diameter of mouthpiece 16: approximately 0.5 inches; inner diameter of mouthpiece 16: 0.375 inches; outer diameter of stem 14: approximately 0.5 inches; inner diameter of stem 14: approximately 0.375 inches: length of stem 14: approximately 3 inches (including mouthpiece 16); bend between stem 14 and bowl 12: approximately 45 degrees; inner diameter of bent portion 20: approximately 0.125 inches; outer diameter of bowl shaft 22: approximately 0.5 inches; inner diameter of bowl shaft 22: approximately 0.375 inches; length of bowl shaft 22: approximately 1 inch; outer diameter of bowl 12: approximately 0.5 inches; inner diameter of bowl shaft: approximately 0.375 inches; and length of bowl section 12: approximately 1 inch. Stem 14 may be formed to have a flat bottom allowing pipe 10 to be stable when set down upon flat surfaces.

FIG. 2 is an illustration of method 200 for manufacturing edible pipe 10 shown in FIGS. 1A-1F. In a first step 202, the fortune cookie batter is prepared. In one specific implementation, the fortune cookie batter includes the ingredients listed in Table 1. In the volumes listed in Table 1, there is enough batter for approximately 432 pipes (576 teaspoons).

TABLE 1

6 Tablespoons Vanilla
7.5 Cups Soybean Oil
20 Cups Flour
1 Cup, 3.5 Tablespoon Cornstarch
3 Tablespoons Salt
20 Cups Sugar
17 oz Water
70 Egg Whites

Optional flavoring may be added to the batter to modify the taste of pipe 10 when consumed. In some cases, the flavorings may even modify a flavor of the smoke as tobacco is consumed using pipe 10 or a scent of pipe 10 as tobacco is burned within bowl 12. Exemplary flavorings include original vanilla, chocolate, coconut, lemon, cappuccino, strawberry, and cinnamon. Alternative flavorings include strawberry extract, coconut emulsion, dark cocoa powder, and orange emulsion which may each be combined into the ingredient listing in Table 1 in the same volume as that shown for Vanilla (6 Tablespoons).

In some implementations cream of tartar (potassium bitartrate) is included in the batter mixture to provide additional strength and preservation of the edible material.

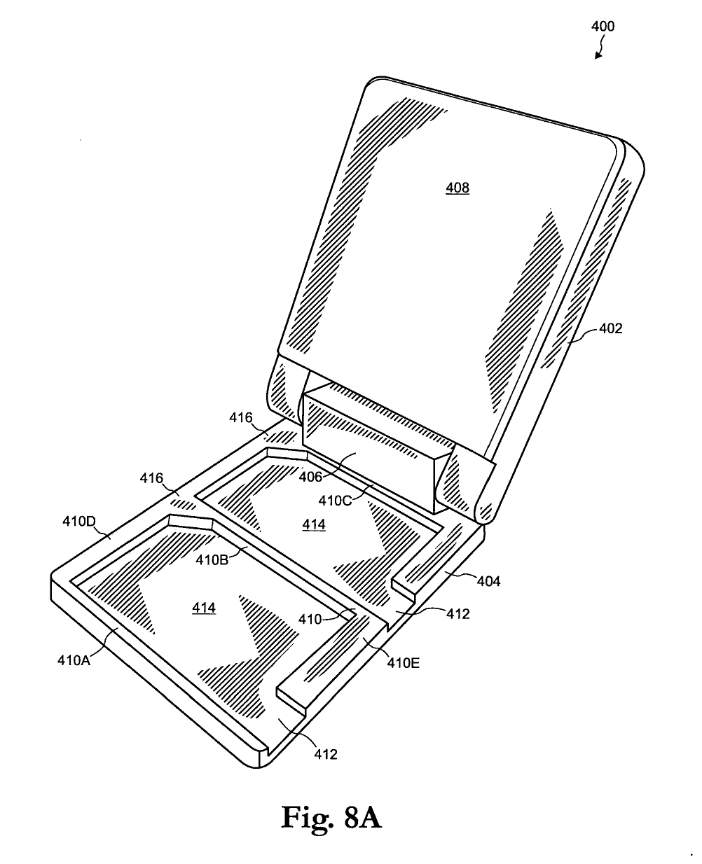

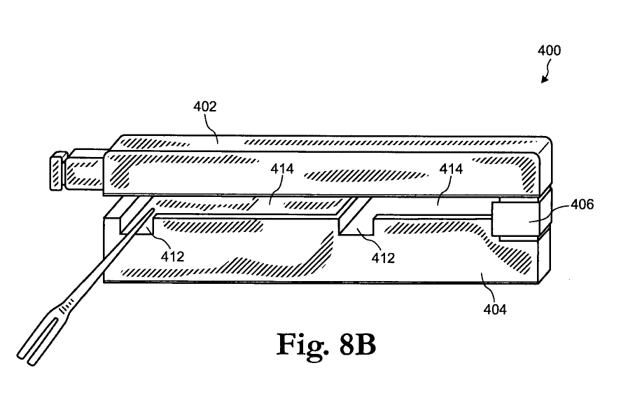

After preparing the batter in step 202, the batter is formed into a patty in step 204 having a generally rectangular shape. In some cases, a corner of the patty is removed (as shown by optional step 206). The portion of the patty from which the corner is removed will comprise the mouthpiece after pipe 10 is formed. The removed corner allows for a more effective seal between a user's mouth and the mouthpiece of the edible pipe. Alternatively, the patty may be formed with the corner already missing using an appropriately shaped mold using, for example, the griddle of FIGS. 8A and 8B described below.

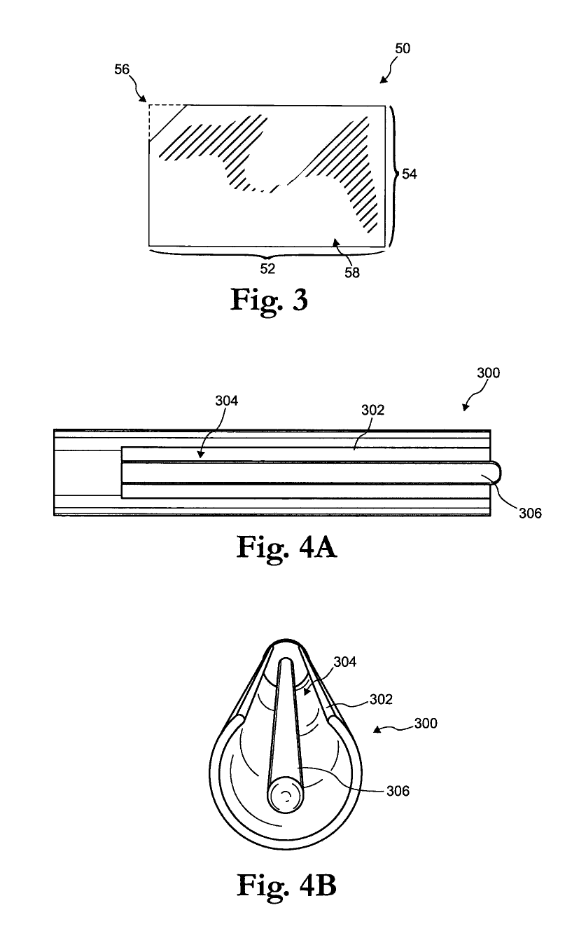

For example, FIG. 3 is an illustration of an example patty prior to formation of the edible pipe. As shown in FIG. 3, patty 50 has a generally rectangular shape with a length 52 and width 54. In one specific implementation, length 52 is approximately 3.5 inches, width 54 is approximately 2 inches, and the patty has a depth of approximately 3/32 inches. Generally, the patty can be formed using approximately 1.5 TBS of batter. Although the portion of the corner that is removed is shown as having a triangular shape in FIG. 3, the removed portion may have any appropriate shape. The removed portion may have a generally square or rectangular shape, a curved shape, a random shape, etc.

After removing corner 56, when patty 50 is formed into the edible pipe, patty 50 is rolled so that the end of patty 50 having removed corner 56 becomes mouthpiece 16. Furthermore, patty 50 is rolled so that the portion of patty 50 having removed corner 56 is wrapped around the outside of mouthpiece 16 and stem 14. As such, the rolling of patty 50 to form edible pipe 10 starts with edge 58 of patty 50. If the removed corner 56 were to be wrapped into the center of mouthpiece 16 and stem 14, the benefits would not be provided.

After forming patty 50, patty 50 is cooked in step 208. After cooking, patty 50 is still pliable and can be rolled and manipulated to form the edible pipe. In one implementation, patty 50 is cooked according to the following procedure, however any appropriate cooking method may be used. In one implementation, the patty is cooked at approximately 475 degrees Fahrenheit for approximately 1.5 minutes.

After cooking patty 50, cooked patty 50 is rolled to form a generally cylindrical shape in step 210. As discussed above, if cooked patty 50 incorporates removed corner 56, the cooked patty is rolled started at an edge of patty 50 located away from removed corner 56 (e.g., the edge designated element ‘58’ in FIG. 3). In step 210, cooked patty 50 may be rolled by hand, mechanical devices, or a combination of by-hand and mechanical devices.

FIGS. 4A and 4B are illustrations of an exemplary rolling device 300 to facilitate performing step 210 of FIG. 2. The rolling device can be used to sculpt the cooked patty into a cylindrical shape and can be used by hand or by an automated manufacturing machine. After the cooked patty is formed into a cylinder using the rolling device, the cooked patty cylinder can be sculpted and formed into the pipe shape as shown in FIGS. 1A-1F.

FIG. 4A shows a side view of rolling device 300. FIG. 4B shows a front view of rolling device 300. Rolling device 300 includes cylindrical wall 302. Opening 304 is formed in cylindrical wall 302. Opening 304 runs along a portion of the length of cylindrical wall 302. The opening in cylindrical wall 302 allows a cooked patty to be introduced into a central volume of rolling device 300. One end of cylindrical wall 302 is closed and provides a mounting surface for shaft 306. Shaft 306 is fixed to the internal surface of the closed end of rolling device 300. Shaft 306 passes through a central volume of rolling device 300.

The dimensions of rolling device 300 (including the dimensions of cylindrical wall 302 and the thickness of shaft 306) together at least partially determine the final dimensions of the cylindrical cooked patty after rolling.

In one specific implementation of rolling device 300, the device has the following dimensions: width: approximately 1.5 inches; length: approximately 6 inches; width of opening in cylindrical wall: approximately 1 inch; length of opening in cylindrical wall: approximately 4 inches; length of internal shaft: approximately 6 inches; and width of internal shaft: approximately 0.25 inches.

Rolling device 300 may be manufactured using any solid materials suitable for the construction of tools or devices used for the production of food products. Example materials includes stainless steel, plastics, ceramic, glass, and PYREX.

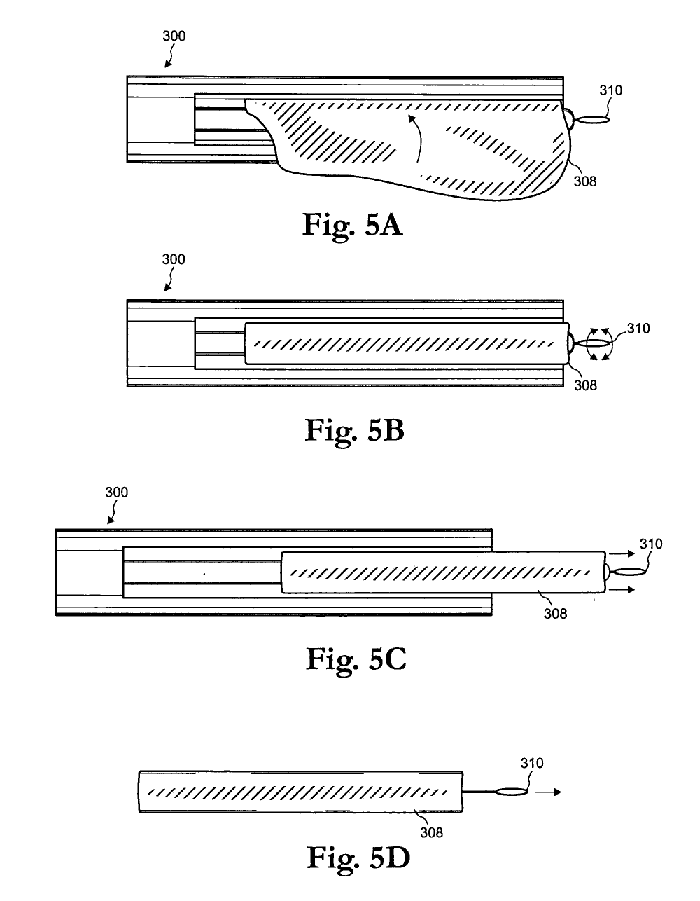

FIGS. 5A-5D illustrate a method for using rolling device 300 of FIGS. 4A and 4B to form a cylindrically-shaped cooked patty. The method may be used to perform step 210 of method 200 illustrated in FIG. 2.

As shown in FIG. 5A, in a first step, a leading edge of the flat, cooked patty 308 is inserted into the central volume of rolling device 300 through opening 304 (see FIGS. 4A and 4B). The patty may be inserted through the side of rolling device 300, or may be slid into the opening starting from the end of rolling device 300. With reference to FIG. 3, the leading edge of an exemplary patty is designated by element ‘58’. The shorter sides of the cooked patty 308 are oriented towards the top and bottom of rolling device 300. If the cooked patty 308 includes a removed corner, as described above, the cooked patty is positioned so that the portion of the patty incorporating the removed corner lays on the trailing edge of the cooked patty (i.e., the last edge of the cooked patty to be inserted into rolling device 300). Accordingly, the leading edge does not incorporate the removed corner.

During insertion of the cooked patty, as shown in FIG. 5A, the leading edge of the cooked patty may be held by tweezers 310 or another gripping device. The tweezers 310 can be used to assist in pulling the cooked patty 308 around shaft 306 of rolling device 300 to form the cooked patty into the cylindrical shape. As shown in FIG. 5B, the tweezers are positioned along the length of the cooked patty that is initial inserted into rolling device 300.

After the cooked patty is inserted into rolling device 300, the leading edge of the cooked patty is pulled or turned around shaft 306 of rolling device 300 (see FIG. 5B). As the cooked patty is pulled around shaft 306 using the tweezers or other gripping device, the cooked patty is rolled-up into a cylindrical shape within rolling device 300 as shown in FIG. 5B. As the cooked patty is pulled around shaft 306, the portion of the cooked patty hanging outside rolling device 300 is pulled into rolling device 300 and cylindrical wall 302 of rolling device 300 forms the cooked patty into a cylindrical shape. In other words, the cooked patty can be wound around shaft 306 within rolling device 300.

Because the cooked patty 308 is wound around shaft 306, the inner diameter of the rolled cooked patty 308 is at least partially determined by the dimensions of shaft 306. Also, because the cylindrical wall 302 of rolling device 300 constrains the cooked patty within rolling device 300, the outer diameter of the rolled cooked patty is at least partially determined by the inner diameter of the cylindrical wall 302 of rolling device 300.

In some cases, rather than pull the cooked patty around shaft 306 of rolling device 300, after insertion of the cooked patty into rolling device 300, rolling device 300 is rotated around the cooked patty to form the patty into the cylindrical shape. In that case, the rotation of rolling device 300 causes the cooked patty to be formed into the cylindrical shape by winding the cooked patty around shaft 306.

This use of rolling device 300 may be particularly useful in automated machines, for example. In that case, the cooked patty may be inserted into rolling device 300 by tweezers or another gripping device that is held steady. After the patty is inserted, rolling device 300 is rotated about the tweezers or gripping device, rolling the cooked patty into the cylindrical shape.

If the cooked patty is held and inserted into rolling device 300 using tweezers or gripping device 310, after insertion, the tweezers or other gripping device is used to pull the cooked patty around shaft 306 of rolling device 300. The tweezers or other gripping device may be used by hand, or may be connected to machinery to automatically pull the cooked patty around the interior of rolling device 300. Depending upon the size of the cooked patty and the dimensions of rolling device 300, the tweezers or other gripping device may be pulled around shaft 306 several times before the entire cooked patty is pulled into the central region of rolling device 300 and wound around shaft 306, forming the entire cooked patty into a cylindrical shape.

After forming the cylindrically shaped cooked patty by winding the patty around shaft 306 of rolling device, the cylindrical patty can be removed from rolling device using the tweezers or other gripping device used to pull the cooked patty around rolling device 300, as shown in FIG. 5C.

If the cooked patty was originally formed with a missing corner, the length of the cooked patty incorporating the missing corner will lay around an exterior of the cylindrically shaped cooked patty.

After removing the cylindrical cooked patty from rolling device 300, the tweezers or other gripping device 310 used to hold the cooked patty can be removed from the patty as shown in FIG. 5D. Then, the cylindrically shaped cooked patty can be formed into the pipe shape shown in FIGS. 1A-1F.

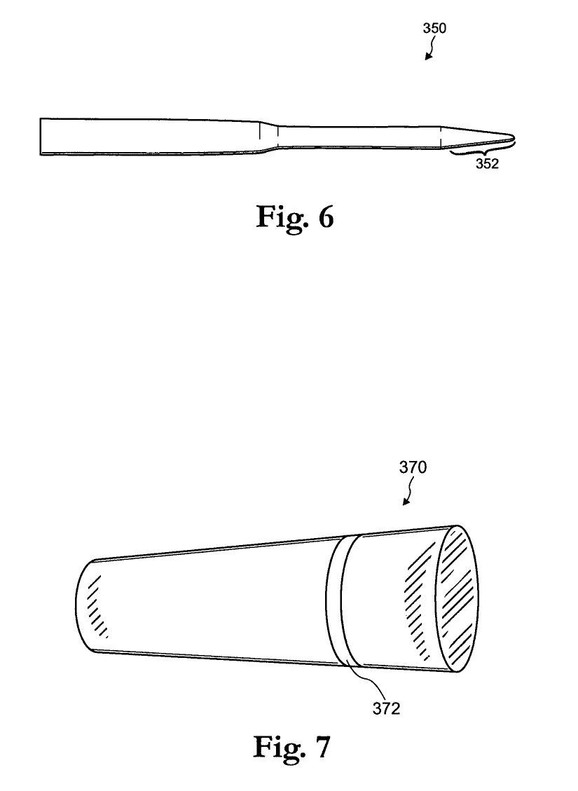

In an alternative implementation, the cooked patty is rolled around rolling stick 350 illustrated in FIG. 6. The dimensions of rolling stick 350 at least partially determine the dimensions of the cooked patty after rolling. In one example implementation, rolling stick 350 has a length of approximately 12 inches and a diameter of approximately 0.125 inches. Rolling stick 350 includes tapered portion 352 that begins approximately 0.5 inches from the end of rolling stick 350. At its narrowest, tapered portion 352 has a diameter of approximately 0.0625 inches. At its thickest, tapered portion 352 has a diameter of approximately 0.125 inches.

When using rolling stick 350, if a corner of the cooked patty was removed, as described above, the length of cooked patty that does not incorporate the removed corner is first rolled around rolling stick 350 so that the length of the patty incorporating the removed corner is the last to be wrapped around rolling stick 350.

In some implementations, where rolling device 300 is used to roll the cooked patty, the dimensions of shaft 306 of rolling device are the same as those of rolling stick 350.

Returning to FIG. 2, after rolling the cooked patty into a cylindrical shape, in step 210, the cylindrical cooked patty is formed into the shape of edible pipe 10. In step 212 the cylindrical patty is first bent to form bend portion 20 (see FIGS. 1A-1F). Bend portion 20 may be formed by hand, or using a machine.

Generally, bend portion 20 is formed at a point along the cylindrical cooked patty approximately two-thirds of the way down the length of the cylindrical patty away from the mouthpiece. In one specific implementation, bend portion 20 is formed three-fifths (⅗) of the way down the length of the cylindrical patty. If the cooked patty includes a removed corner, the mouthpiece is located at the end of the cooked patty having the removed corner. If, however, the cooked patty includes no removed corners, the mouthpiece can be located at either end of the cylindrical cooked patty. The bowl of the pipe is located at the end of the cylindrically shaped patty opposite the mouthpiece.

After forming bend portion 20, in an optional step 214, bowl 12 is formed. Step 214 may involve sculpting the bowl portion to expand the volume enclosed by bowl 12 so as to shape bowl 12. This may involve forming bowl 12 into a rounded structure, requiring that the walls of the cylindrical patty be expanded outwards at bowl 12. This step may be performed by hand or using a machine. This step, however, is optional as, in some cases, bowl 12 may be defined to include the portion of the cylindrical cooked patty extending away from the bent portion, opposite the mouth piece and may be no wider than bowl shaft 22.

In one example, a cone-shaped bowl plug is inserted into the bowl portion of the edible pipe to form the shape of bowl 12. The cone-shaped plug may include a rubber or other appropriate material for use with food products and is shown in FIG. 7. In one implementation, plug 370 has a length of approximately 1.125 inches. At its widest, plug 370 has a diameter of approximately 0.4375 inches. At its narrowest, plug 370 has a diameter of approximately 0.25 inches. Plug 370 may include marking 372 indicating a stop point to prevent over-insertion of plug 370 into bowl 12 of the edible pipe. At marking 372, the diameter of plug 370 is approximately 0.375 inches and is located approximately 0.3125 inches from the thickest portion of plug 370 and is approximately 0.75 inches from the narrowest portion of plug 370.

After inserting plug 370 into bowl 12 of the edible pipe, the pipe may be placed onto a cooling rack until the edible pipe has been hardened and plug 370 can be removed and reused.

After bending the cooked patty, in optional step 216, a moisture resistant coating may be formed or deposited over the mouthpiece to provide moisture protection, as described above. The wax may be flavored and may include an edible material.

After the cylindrical cooked patty is formed into the edible pipe, the pipe can be placed into a mold or die sheet for cooling and hardening. The die sheet includes a solid structure having recesses formed in the shape of the edible pipe. The formed pipes can be placed into the mold or die sheet and left to cool. As the pipes cool, the material making-up the pipes hardens into the shape defined by the mold or die sheet. The mold or die sheet includes a solid substrate into which the die shapes are formed. The shapes may be formed using a precision plasma cutter, or other tools and mechanisms for forming the die sheet. The mold or die sheet can be coated with a TEFLON or other non-stick coating to facilitate retrieval of the edible pipes from the die sheet.

In various implementations of the present system, the edible pipe may be manufactured using automated machinery. Various machines exist for the manufacture of fortune cookies. One example machine is shown in U.S. Pat. No. 4,339,993 to Yongsik Lee.

Generally, the fortune cookie manufacturing devices include rotatable assemblies that carry a number of griddles. The griddles are used to form oval cooked patties by passing the griddles through an oven. Once cooked, the patties are then formed into the well-known fortune cookie shape. Although machines exist for automatically manufacturing fortune cookies, the machines are not well suited to manufacturing the present edible pipe. For example, the machines all incorporate griddles that cannot be used in manufacturing the present edible pipe.

FIGS. 8A and 8B are illustrations of an example griddle for use in an automated cookie fabrication machine for manufacturing the present edible pipe. FIG. 8A provides a perspective view, while FIG. 8B shows a side view. Griddle 400 includes top plate 402 and bottom plate 404. Griddle 400 can be used to cook the cookie batter as required by step 208 shown in FIG. 2. Griddle 400 is configured to be used within automated machinery for facilitating the manufacture of edible pipe 10. But griddle 400 may also be used by hand, with no integration into automated machinery.

Using griddle 400, batter is deposited between top plate 402 and bottom plate 404 over bottom plate 404. Both plates are heated and the top plate is brought down towards the bottom plate to contact the batter and/or the lower plate. Heat is then transferred from the top and bottom plate of griddle 400 into the batter to cook the batter.

Top plate 402 and bottom plate 404 may be constructed from materials effective at storing significant amounts of energy (i.e., having a high heat capacity). Example materials include metals such as steel, glass, ceramic, etc. Each of top plate 402 and bottom plate 404 may also include a heating element (e.g., an electric or gas heating element) disposed within either of top plate 402 and bottom plate 404, or both plates for heating the plates and cooking the batter.

Alternatively, griddle 400 may only act a mold for containing the batter during the cooking process, with griddle 400 being placed proximate to a heat source for cooking the batter. In that case, once again, batter is deposited between the top and bottom plates of griddle 400. To cook the batter, the top plate 402 is brought down over bottom plate 404 and the entire griddle 400 is inserted into an oven or furnace to cook the batter.

Referring back to FIGS. 8A and 8B, top plate 402 and bottom plate 404 are connected by hinge 406 allowing top plate 402 to be lifted away from bottom plate as shown in FIG. 8A or to be brought down in close proximity to or contacting bottom plate 404.

In one specific implementation of griddle 400, top plate 402 has a thickness of approximately 1 inch and bottom plate 404 has a thickness of approximately 0.375 inches. The length of both top plate 402 and bottom plate 404 (extending away from hinge 406) is approximately 5.375 inches and the width is approximately 4 inches.

Bottom surface 408 of top plate 402 may be coated with a non-stick coating such as Polytetrafluoroethylene (PTFE), Perfluoroalkoxy, or fluorinated ethylene propylene, for example. Other non-stick coatings, such as oils including vegetable oil, and olive oil, and melted fats may be used. Because bottom surface 408 of top plate 402 is coated with a non-stick surface, after the cookie batter is cooked in griddle 400 and top plate 402 is raised away from bottom plate 404, the cooked patty does not stick to the top plate. Accordingly, the cooked patty remains on bottom plate 404 and can be retrieved from bottom plate 404. This operation is in direct contrast to prior fortune cookie griddle operation, where the machines require that the patty be stuck to the top plate to allow for retrieval of the cooked patty from the top plate allowing the machine to function correctly.

Mold 410 is formed over bottom plate 404. Mold 410 may include a separate structure that is fastened to bottom plate 404, or may be formed integrally with bottom plate 404. Mold 410 includes several walls 410A, 4106, 410C, 410D and 410E that define two volumes or recessed portions 414 over bottom plate 404. In alternative implementations of griddle 400, however, fewer recessed portions (e.g., a single recessed portion for forming a single patty), or more recessed portions can be formed over bottom plate 404. Alternatively, each of the recessed portions may be formed with different sizes. In one implementation, a first recessed portion has dimensions of approximately 3.25 inches by 2.25 inches, while a second recessed portion has dimensions of approximately 3.25 inches by 1.5 inches. The larger recessed portions will form a larger patty allow for more wraps of patty during the rolling process resulting in a stronger edible pipe.

During cooking, cookie batter is poured into each recessed portion 414 of mold 410 for shaping the cookie batter before cooking. As shown in both FIGS. 8A and 8B, mold 410 includes two recessed portions that are each approximately rectangular in shape. Each mold 410, however, includes an optional raised corner portion 416. After pouring batter into each mold 410, the raised corner portion 416 causes the shaped batter to have a removed corner portion, such as that illustrated in FIG. 3 (see corner 56 of patty 50).

After depositing cookie batter into recessed portions 414, top plate 402 is brought down over bottom plate 404 and the cookie batter is cooked.

After the cooking process is complete, a cooked patty is removed from one of recessed portions 414 of griddle 400. The cooked patty is then rolled, as described above and in step 210 of FIG. 2.

When using tweezers to grab the cooked patty from griddle 400, the tweezers can be inserted through windows 412 of mold 410 to grasp the patty. Window 412 allows a first arm of the tweezers to be positioned above the cooked patty, while a second arm of the tweezers can be positioned beneath the cooked patty, facilitating removal of the cooked patty from griddle 400. Furthermore, as shown in FIG. 8A, windows 412 are positioned so that when tweezers are inserted through windows 412 to grasp the cooked patty, the tweezers are positioned to grasp the patty along the patty's leading edge (i.e., edge 58 as shown in FIG. 3) for efficient rolling, for example by using rolling device 300 shown in FIGS. 4A and 4B. Windows 412 are optional, however, and walls of mold 410 may be formed continuously around the perimeter of recessed portions 414.

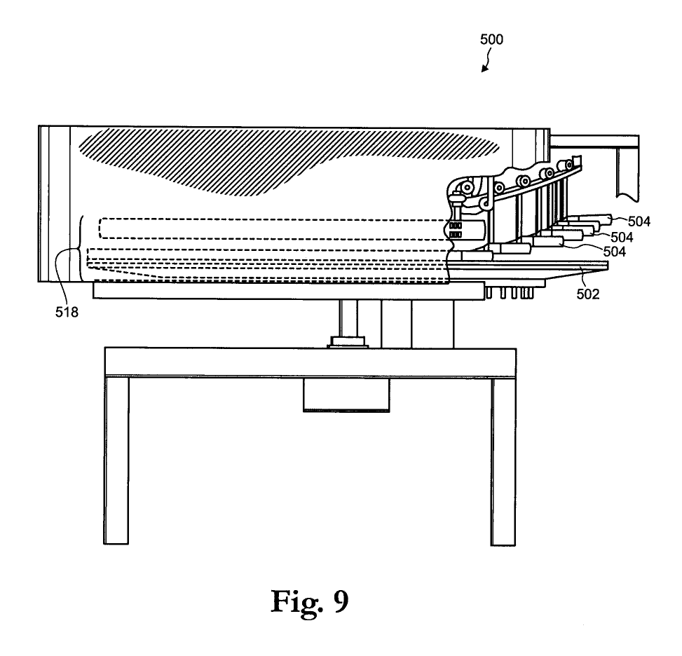

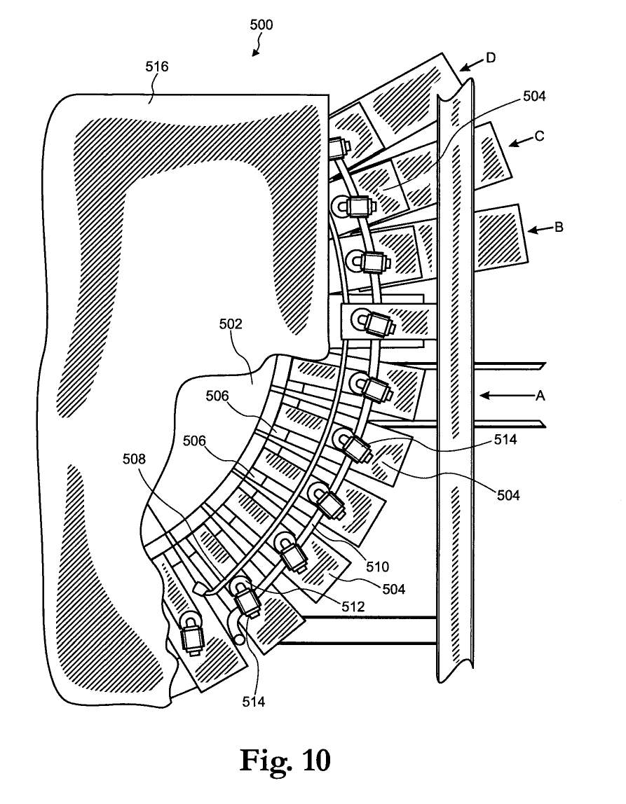

FIGS. 9 and 10 are illustrations of an example baking machine incorporating the griddle illustrated in FIGS. 8A and 8B for manufacturing the present edible pipe. FIG. 9 shows a side view of the machine with a portion of the hood removed to expose the internal mechanisms of the baking assembly. FIG. 10 shows a top view of the machine with a portion of the hood removed to expose the internal mechanisms of the baking assembly.

Referring to FIG. 9, the baking machine includes baking assembly 500. Baking assembly 500 contains rotating turret 502 that is configured to carry griddles 504. Rotating turret 502 moves through a series of stations allowing for the receipt of cookie batter into griddles 504, the cooking of the cookie batter, and the retrieval of the cooked patty from griddles 504. As rotating turret 502 rotates, griddles 504 are automatically opened and closed, allowing for the operation of baking assembly 500, as described below.

When using baking assembly 500, in a first step, batter is deposited into griddles 504. The batter may be deposited, for example, using a vacuum piston. Griddles 504 may be configured in accordance with the griddle illustrated in FIGS. 8A and 8B to mold the patty in accordance with FIG. 3. After the cookie patties are baked within griddles 504, the cooked griddles are retrieved and formed into edible pipe 10.

The rotating turret 502 of baking assembly 500 carries a number of griddles 504. As described above, each griddle 504 includes a top and bottom plate, with molding walls formed over the bottom plate. The top plate incorporates a non-stick surface, again, as described above.

Each griddle 504 is connected to rotating turret 502. The upper plate of each griddle 504 may be connected to a cam roller for opening and closing griddles 504 as the griddles rotate about baking assembly 500.

Each cam roller follows one of cam tracks 508 and 510 (see FIG. 10) through an arc of approximately 120 degrees. As rotating turret 502 rotates within baking assembly 500, cam rollers 512 and 514 first engage the cam tracks at their leading ends, and the tracks gradually rise and move radially inwardly for approximately 60 degrees. Then the cam tracks return to the same relative positions as the leading ends of the cam tracks.

With reference to FIGS. 9 and 10, the cam tracks cause the cam rollers to elevate, incline, and move slightly inward in a radial direction causing the upper plate of griddles 504 to separate from the lower plate. After being opened, cam rollers 512 and 514 under the influence of the cam tracks return the upper plate of griddle 504 to the closed position.

As shown in FIGS. 9 and 10, baking assembly 500 includes hood 516 that encloses a portion of rotating turret 502 excluding the positions where griddles 504 are in an open position. Within the enclosed portion of hood 516 burners 518 are positioned above and below griddles 504 when griddles 504 are rotated through hood 516. Burners 518 heat griddles 504 for cooking the cookie batter deposited therein.

Baking assembly 500 is configured to automatically cook cookie patties having the configuration shown in FIG. 3. After cooking, the cooked cookie patties can be rolled using the processes described above. After rolling, the patty can be formed in the edible pipe, again, as described above, and placed into a die for cooling and hardening.

To use baking assembly 500, burners 518 are first ignited and rotating turret 502 is rotated. As rotating turret 502 rotates, each one of griddles 504 passes through the station labeled ‘A’ in FIG. 10. As the griddle 504 passes through station A, due to the curvature of tracks 508 and 510 and cam rollers 512 and 514, the griddle 504 is opened by lifting the top plate of griddle 504 away from the bottom plate allowing for retrieval of a cooked patty.

After the cooked patty is retrieved from the griddle 504 occupying station A, the rotating turret 502 continues to rotate moving griddles 504 in a counter-clockwise direction (with reference to FIG. 10) through stations B, C, and D. In each of stations B, C, and D, baking assembly 500 can perform different activities including cleaning griddles 504, oiling or greasing griddles 504, and depositing batter into griddles 504. After the batter is deposited, griddles 504 continue to be rotated counter-clockwise, through baking assembly 500 and the batter in griddles 504 is cooked by burners 518.

The motor that drives rotating turret 502 and the connected griddles 504 in a counter-clockwise direction may be configured as a stepper motor allowing each of griddles 504 to pause for a pre-determined period of time in each station allowing for removal of the cooked patty, cleaning, oiling and deposit of fresh batter.

After each griddle 504 departs station D, cam rollers 512 and 514 in cooperation with tracks 508 and 510 cause griddles 504 to close by lowering the top plate towards the bottom plate in preparation for cooking.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

We claim:

1. An edible pipe including a bowl, a stem, and a mouthpiece manufactured by a process, the process including:
forming a patty having an approximately rectangular shape, the patty including fortune cookie batter;
cooking the patty;
rolling the cooked patty into a cylindrical shape by:
inserting the cooked patty into a rolling device, the rolling device including a cylindrical wall having a closed end, the cylindrical wall defining an interior volume of the rolling device and including an opening along a length of the cylindrical wall for receiving the cooked patty, the rolling device including a shaft mounted to the closed end, the shaft running through the interior volume of the rolling device, winding the cooked patty around the shaft of the rolling device, and
removing the rolled cooked patty from the rolling device; and
forming a bend in the rolled cooked patty to form the edible pipe.

2. The process of claim 1, including forming a moisture resistant coating over at least a portion of the mouthpiece of the edible pipe, the moisture resistant coating including an edible wax material.

3. The process of claim 1, including depositing a plug into one end of the rolled cooked patty to form the bowl of the edible pipe.

4. The process of claim 1, including depositing one or more flavorings into the patty, the one or more flavorings including at least one of original vanilla, chocolate, coconut, lemon, cappuccino, strawberry, and cinnamon.

5. The process of claim 1, including removing a portion of a first corner of the patty before cooking the patty.

6. The process of claim 5, wherein, after rolling the cooked patty, the first corner of the patty forms at least a portion of an outer layer of the cylindrical cooked patty.

7. The process of claim 1, wherein each of the bowl, stem, and mouthpiece of the edible pipe are in fluid communication.

8. The process of claim 1, including using tweezers to wind the cooked patty around the shaft of the rolling device.

9. A method of manufacturing an edible pipe having a mouthpiece, stem and bowl, the method comprising:
forming a patty having an approximately rectangular shape, the patty including fortune cookie batter;
cooking the patty;
rolling the cooked patty into a cylindrical shape; and
forming a bend in the rolled cooked patty to form the edible pipe.

10. The method of claim 9, including forming a moisture resistant coating over at least a portion of the mouthpiece of the edible pipe, the moisture resistant coating including an edible wax material.

11. The method of claim 9, including depositing a plug into one end of the rolled cooked patty to form the bowl of the edible pipe.

12. The method of claim 11, including depositing one or more flavorings into the patty, the one or more flavorings including at least one of original vanilla, chocolate, coconut, lemon, cappuccino, strawberry, and cinnamon.

13. The method of claim 9, including removing a portion of a first corner of the patty before cooking the patty.

14. The method of claim 13, wherein, after rolling the cooked patty, the first corner of the patty forms at least a portion of an outer layer of the cylindrical cooked patty.

15. The method of claim 9, wherein each of the bowl, stem, and mouthpiece of the edible pipe are in fluid communication.

16. The method of claim 9, wherein rolling the cooked patty into a cylindrical shape includes:
inserting the cooked patty into a rolling device; and
pulling the cooked patty around a central shaft of the rolling device.

17. A method for manufacturing an edible pipe having a mouthpiece, stem and bowl, comprising:
forming a patty having an approximately rectangular shape, the patty including fortune cookie batter;
removing a portion of a first corner of the patty;
cooking the patty;
rolling the cooked patty into a cylindrical shape;
forming a bend in the rolled cooked patty to form the edible pipe; and
forming a moisture resistant coating over at least a portion of the mouthpiece of the edible pipe, the moisture resistant coating including an edible wax material.

18. The method of claim 17, wherein, after rolling the cooked patty, the first corner of the patty forms at least a portion of an outer layer of the cylindrical cooked patty.

19. The method of claim 17, wherein each of the bowl, stem, and mouthpiece of the edible pipe are in fluid communication.

20. An edible pipe, comprising:
a cooked batter composition, the cooked batter composition having a mouthpiece, a stem, and a bowl, the mouthpiece, stem and bowl being in fluid communication, and a bend being formed in the cooked batter composition between the stem and the bowl; and
a moisture resistant coating formed over the mouthpiece.
